(19) United States
(12) Patent Application Publication
(10) Pub. No.: US 2024/0273524 A1
(43) Pub. Date: Aug. 15, 2024

(54) BLOCKCHAIN-BASED SUBSCRIPTION MODEL

(71) Applicant: Stripe Inc., South San Francisco, CA (US)

(72) Inventors: Sen Forest Fang, South San Francisco, CA (US); Brendan Ryan, South San Francisco, CA (US)

(73) Assignee: Stripe Inc., South San Francisco, CA (US)

(21) Appl. No.: 18/108,379

(22) Filed: Feb. 10, 2023

(51) Int. Cl. G06Q 20/38; G06Q 20/36

(52) U.S. Cl. CPC G06Q 20/389; G06Q 20/367

(57) ABSTRACT

Disclosed herein are systems and methods for generating and managing subscription using electronic transaction protocols in a blockchain-based system. In an embodiment, a system monitors one or more electronic transaction protocols deployed on a blockchain; detects an interaction by a decentralized wallet with a user interface element corresponding to a first electronic transaction protocol of the one or more electronic transaction protocols deployed on the blockchain; identifies one or more parameters of the subscription based on one or more inputs provided via the decentralized wallet, wherein the one or more parameters includes a time period of the subscription and a payment interval; and causes a first service provider to create or modify the subscription associated with a user of the decentralized wallet, wherein the causing further includes creating or modifying the subscription based on the one or more parameters.

### TECHNICAL FIELD

This application relates generally to monitoring electronic transaction protocols (e.g., smart contracts) on a blockchain infrastructure to generate and manage subscriptions.

### BACKGROUND

As the processing power of computers allows for greater computer functionality and the Internet technology era allows for interconnectivity between computing systems, many institutions are shifting towards blockchain-based technology to store and maintain the integrity of transaction data. While blockchain-based storage methods may require more computational resources than conventional methods (e.g., a central database), the immutability of the data within the blockchain enables operators to have peace of mind that the data in the blockchain is accurate and will not be changed.

Current blockchain-based systems can execute electronic transaction protocols (e.g., smart contracts or other sets of executable code) to perform transactions using a blockchain. The electronic transaction protocols can be deployed onto the blockchain. The computers that maintain the blockchain can execute the electronic transaction protocols to perform the transactions upon determining that conditions of the electronic transaction protocols are met. Because the electronic transaction protocols are maintained on the blockchain and can complete the transactions by writing the transaction data into the blockchain, electronic transaction protocols offer improved security and validation of transactions between entities.

### SUMMARY

There is a desire for methods and systems to provide a system for facilitating online subscriptions using electronic transaction protocols and/or a blockchain-based infrastructure. What is also desired is methods and systems to use blockchain-based technology to generate an automatic subscription system in which a user's decentralized wallet pays (e.g., automatically pays or pays upon receipt of a request) subscription fees without transmitting any personally identifiable information (PII) or personal financial information to a service provider.

Disclosed herein are methods and systems associated with a blockchain-based subscription management system. The blockchain-based subscription management system can deploy electronic transaction protocols onto a blockchain (e.g., a blockchain maintained or managed by one or more nodes owned or managed by a third party) for different service providers. The electronic transaction protocols can each correspond to a subscription (e.g., a subscription service) managed or provided by a different service provider. Through a decentralized wallet interface, a user can access and provide inputs to the different deployed electronic transaction protocols to “sign up” for subscriptions to services provided by the different service providers. The disclosed blockchain-based subscription management system provides a mechanism through which users can subscribe to different services using their decentralized wallets.

Using a blockchain-based subscription management system can enable automatic payments to service providers without transmitting personal information for the subscriptions to the service providers. For example, electronic transaction protocols with which users interact to establish subscriptions may execute and automatically pull tokens or other payment currency from the users' decentralized wallets. The electronic transaction protocols may do so upon detecting satisfaction of a condition, such as the end of a payment interval. The electronic transaction protocols can transfer the tokens to decentralized wallets of the service providers to maintain the subscriptions. Accordingly, the blockchain-based subscription management system can automatically manage subscriptions of users or decentralized wallets by deploying electronic transaction protocols onto a blockchain and monitoring the electronic transaction protocols for interactions through a decentralized wallet interface.

In an embodiment, a method comprises monitoring, by a first system, one or more electronic transaction protocols deployed on a blockchain, wherein the one or more electronic transaction protocols correspond to one or more subscriptions provided by one or more service providers; detecting, by the first system, an interaction by a decentralized wallet with a user interface element corresponding to a first electronic transaction protocol of the one or more electronic transaction protocols deployed on the blockchain, wherein the interaction corresponds to a request to create or modify a subscription with a first service provider of the one or more service providers, the request comprising an identifier associated with the decentralized wallet; identifying, by the first system, one or more parameters of the subscription based on one or more inputs provided via the decentralized wallet, wherein the one or more parameters includes a time period of the subscription and a payment interval; and in response to identifying the one or more parameters of the subscription and identifying that the first electronic transaction protocol corresponds to the first service provider, causing the first service provider to create or modify the subscription associated with a user of the decentralized wallet, wherein the causing further includes creating or modifying the subscription based on the one or more parameters.

In another embodiment, a system comprises a non-transitory storage medium comprising a set of instructions that when executed, cause a processor to: a non-transitory computer-readable medium having a set of instructions that when executed by a processor, cause the processor to monitor one or more electronic transaction protocols deployed on a blockchain, wherein the one or more electronic transaction protocols correspond to one or more subscriptions provided by one or more service providers; detect an interaction by a decentralized wallet with a user interface element corresponding to a first electronic transaction protocol of the one or more electronic transaction protocols deployed on the blockchain, wherein the interaction corresponds to a request to create or modify a subscription with a first service provider of the one or more service providers, the request comprising an identifier associated with the decentralized wallet; identify one or more parameters of the subscription based on one or more inputs provided via the decentralized wallet, wherein the one or more parameters includes a time period of the subscription and a payment interval; and in response to identifying the one or more parameters of the subscription and identifying that the first electronic transaction protocol corresponds to the first service provider, cause the first service provider to create or modify the subscription associated with a user of the decentralized wallet, wherein the causing further includes creating or modifying the subscription based on the one or more parameters.

### BRIEF DESCRIPTION OF THE DRAWINGS

Non-limiting embodiments of the present disclosure are described by way of example with reference to the accompanying figures, which are schematic and are not drawn to scale. Unless indicated as representing the background art, the figures represent aspects of the disclosure.

FIG. 1 illustrates various components of a blockchain-based subscription management system, according to an embodiment.

FIG. 2 illustrates a flow diagram of a method executed in a blockchain-based subscription management system, according to an embodiment.

FIG. 3 illustrates a flow diagram of a method executed in a blockchain-based subscription management system, according to an embodiment.

FIG. 4 illustrates a flow diagram of a method executed in a blockchain-based subscription management system, according to an embodiment.

FIG. 5 illustrates a sequence of appending a block instance to a blockchain, according to an embodiment.

FIG. 6 graphically illustrates implementing a blockchain-based subscription management system, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein—and additional applications of the principles of the subject matter illustrated herein—that would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting of the subject matter presented.

As will be described below, a server (referred to herein as the analytics server) can use a blockchain-based system to manage subscriptions to enable users to use their decentralized wallets to sign up and pay for various subscriptions. In some cases, the server can enable such wallets to do so while maintaining the privacy of the owners of the decentralized wallets.

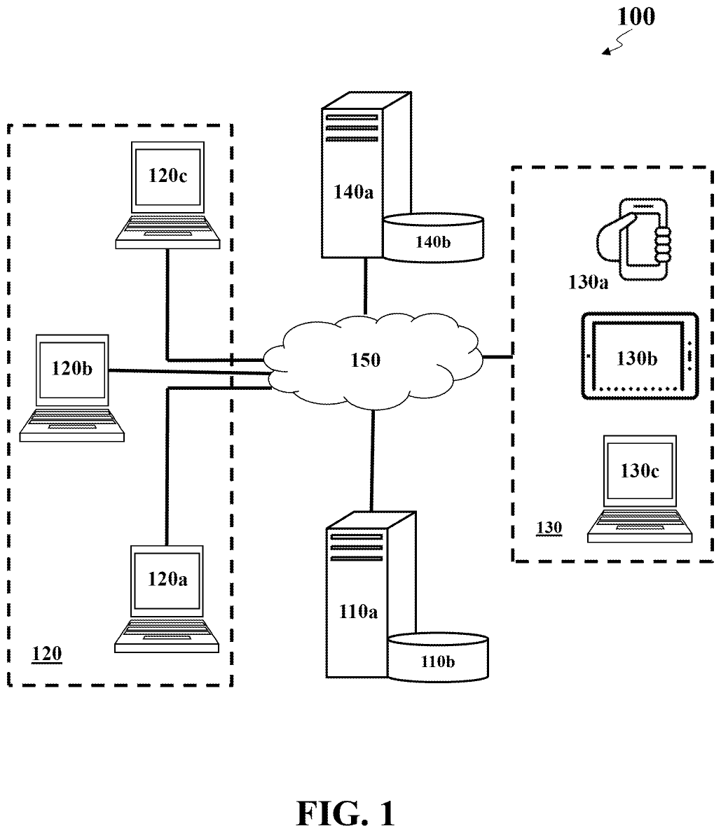

FIG. 1 is a non-limiting example of components of a blockchain-based subscription management system 100 in which an analytics server 110a operates. The analytics server 110a may utilize features described in FIG. 1 to monitor electronic transaction protocols deployed on a blockchain for inputs and generate subscriptions to services provided by service providers based on detected interactions with the electronic transaction protocols. The system 100 is not confined to the components described herein and may include additional or other components not shown for brevity, which are to be considered within the scope of the embodiments described herein.

The analytics server 110a may be communicatively coupled to computers 120a-120c (computers 120) that operate to maintain a blockchain, a server 140a of a service provider, and client devices 130a-130c (client devices 130). The analytics server 110a, the computers 120, the client devices 130, and the server 140a may each be a client device, computing device, server, or any other type of computer that includes a processor and memory. The analytics server 110a may monitor interactions between decentralized wallets stored or accessed at the client devices 130 and electronic transaction protocols of the blockchain maintained by the computers 120.

The above-mentioned components may be connected through a network 150. The examples of the network 150 may include, but are not limited to, private or public LAN, WLAN, MAN, WAN, and the Internet. The network 150 may include both wired and wireless communications according to one or more standards and/or via one or more transport mediums.

The communication over the network 150 may be performed in accordance with various communication protocols such as Transmission Control Protocol and Internet Protocol (TCP/IP), User Datagram Protocol (UDP), and IEEE communication protocols. In one example, the network 150 may include wireless communications according to Bluetooth specification sets or another standard or proprietary wireless communication protocol. In another example, the network 150 may include communications over a cellular network, including, e.g., a GSM (Global System for Mobile Communications), CDMA (Code Division Multiple Access), and/or EDGE (Enhanced Data for Global Evolution) network.

The computers 120 can cooperate to maintain a blockchain or another type of distributed ledger. The blockchain can store data for individual transactions in different block instances (e.g., blocks) within the blockchain. The computers 120 can also store electronic transaction protocols on the blockchain. Electronic transaction protocols can be or include any automated and/or unilateral protocol, such as a smart contract, that the computers 120 can execute to perform or otherwise facilitate different transactions. The computers 120 can execute the electronic transaction protocols upon satisfaction of different conditions stored within the electronic transaction protocols. In executing the electronic transaction protocols, the computers 120 can write or append new block instances to the blockchain that correspond to different transactions.

The computers 120 or a server managing the computers 120 can generate and/or manage an electronic platform. In some cases, the analytics server 110a can manage or manage the electronic platform with the computers 120. Users at different client devices 130 can access the electronic platform through decentralized wallets. As used herein, a decentralized wallet may refer to a virtual wallet that allows users to store, send, and receive digital (e.g., blockchain-based) currencies, such as bitcoin, or make electronic payments for goods and services using their mobile device or computer. A decentralized wallet can be or include an executable application and/or an account on such an executable application. Decentralized wallets typically use encryption and other security measures to protect the user's financial information and transactions. The decentralized wallets can be stored or executing on the respective client devices 130. Via the electronic platform, the users can access different electronic transaction protocols that are stored on the blockchain maintained by the computers 120 and/or the analytics server 110a. The users can provide inputs requesting to change or update the electronic transaction protocols and/or indications of how to change or update the electronic transaction protocols.

The analytics server 110a and the server 140a may be any computing device comprising a processor and non-transitory, machine-readable storage capable of executing the various tasks and processes described herein. The analytics server 110a and the server 140a may employ various processors such as a central processing unit (CPU) and graphics processing unit (GPU), among others. Non-limiting examples of such computing devices may include workstation computers, laptop computers, server computers, and the like. While the system 100 includes a single analytics server 110a and server 140a, the analytics server 110a and server 140a may include any number of computing devices operating in a distributed computing environment, such as a cloud environment.

The analytics server 110a may deploy electronic transaction protocols onto the blockchain maintained by the computers 120. The electronic transaction protocols can each include executable code configured by the computer that deployed the respective electronic transaction protocols (e.g., the analytics server 110a). The computers 120 maintaining the blockchain on which the electronic transaction protocols are stored can execute the electronic transaction protocols to perform any actions of the executable code. The electronic transaction protocols can correspond to subscriptions for different service providers (e.g., content service providers, such as service providers of a software-as-a-service product). The analytics server 110a can receive a request from computers or servers owned by a service provider (e.g., the server 140a) to deploy an electronic transaction protocol for the service provider onto the blockchain. In one example, the request can include an identifier (e.g., a numeric or alphanumeric string) of the service provider and/or parameters or terms for the electronic transaction protocol (e.g., a cost or value of the electronic transaction protocol, a term or length of the electronic transaction protocol, levels of the electronic transaction protocol, conditions of the electronic transaction protocol, or other terms of the electronic transaction protocol). The analytics server 110a can receive the request and transmit a request (e.g., a request including the identifier of the service provider and/or the terms or parameters of the requested electronic transaction protocol) to one or more of the computers 120 to generate or deploy an electronic transaction protocol onto the blockchain. One or more of the computers 120 can receive the request and generate or write an electronic transaction protocol including the requested terms and conditions onto the blockchain maintained by the computers 120.

The analytics server 110a can monitor one or more electronic transaction protocols on the blockchain (e.g., monitor the electronic transaction protocols that the analytics server 110a has deployed onto the blockchain). The analytics server 110a can monitor the one or more electronic transaction protocols by accessing the electronic platform maintained by the computers 120 and determining any decentralized wallets are accessing or have otherwise interacted with the electronic transaction protocols. In some cases, the analytics server 110a can monitor the one or more electronic transaction protocols on the blockchain by polling the computers 120 for updates to the electronic transaction protocols or by transmitting (e.g., via an application programming interface) instructions or a request to the computers 120 indicating for the computers 120 to transmit any updates to the electronic transaction protocols to the analytics server 110a. The analytics server 110a can transmit such instructions or requests to the computers 120 when deploying the electronic transaction protocols onto the blockchain managed by the computers 120.

The client devices 130 may represent various electronic components that store and maintain decentralized wallets for different users. Therefore, the client devices 130 may include various hardware and software components. For instance, the client devices 130 may each execute a decentralized wallet that corresponds to an individual user. Executing the decentralized wallet can connect the client devices 130 to the electronic platform maintained by the computers 120. Via the electronic platform, the client devices 130 can access the different electronic transaction protocols deployed onto the blockchain maintained by the computers 120, such as the electronic transaction protocols deployed by the analytics server 110a. Users accessing the client devices 130 can select electronic transaction protocols to access and interact with the electronic transaction protocols. The users can do so by adjusting or otherwise updating the electronic transaction protocols. In one example, the users can provide inputs that cause the computers 120 to request to create or modify a subscription with a service provider (e.g., a first service provider for which the analytics server 110a deployed an electronic transaction protocol). Such a request can include an identifier of a wallet that was used to transmit or that otherwise transmitted the request. The request can also include one or more parameters (e.g., a time period of a subscription and/or a payment interval) as input by a user accessing the electronic transaction protocol.

One or more of the computers 120 can transmit a message indicating a request to create or modify a subscription with a service provider (e.g., a first service provider) that the computers 120 receive through one of the electronic transaction protocols. The request can include an identifier of the decentralized wallet through which the request was made and parameters for the creation or modification of the subscription. The computer 120 can transmit the request to the analytics server 110a. Upon receipt of the request, the analytics server 110a can transmit a message to the server 140a indicating the request, the parameters of the request, and/or the identifier of the decentralized wallet that was used to make the request.

The server 140a can receive the request and generate, create, or modify a subscription based on the request. For example, if the request is a request to create a subscription, the server 140a can generate and store a record (e.g., a file, document, table, listing, message, notification, etc.) in a database 140b (e.g., a relational database). The server 140a can generate the record to include the parameters of the subscription and/or the identifier of the decentralized wallet that made the subscription. The server 140a can also generate the record to include login credentials that can be used to access services or content provided by the server 140a or the service provider associated with the server 140a. Advantageously, in some cases, the record may only include the identifier of the decentralized wallet (or an anonymized identifier of the decentralized wallet, which can be generated by the server 110a) and not any other PII of the owner of the decentralized wallet, therefore maintaining the privacy of the subscriber. The record can include any type of data necessary to maintain and/or fulfill the subscription for the decentralized wallet.

The analytics server 110a can additionally or instead cause a transaction to be written to the blockchain maintained by the computers 120 (e.g., cause a block for the transaction to be appended to the blockchain). The analytics server 110a can do so by transmitting a message to the computers 120 indicating the subscriptions and/or the parameters of the subscriptions. In some cases, the analytics server 110a can do so by configuring the electronic transaction protocol associated with the subscription to write transactions for the subscriptions based on interactions or inputs by users for requests to modify or create a subscription with the electronic transaction protocol. The computers 120 can execute the electronic transaction protocol and write a transaction to the blockchain to write the subscription onto the blockchain.

The analytics server 110a can manage subscriptions through the electronic transaction protocols on the blockchain. The analytics server 110a can store data for such subscriptions in a database 110b (e.g., a relational database). For example, the analytics server 110a can configure the electronic transaction protocols to automatically pull payments from wallets that have subscribed to services provided by different service providers. The analytics server 110a can configure the electronic transaction protocols to do so responsive to the conditions of the electronic transaction protocols being satisfied. The electronic transaction protocols can identify the identifiers or addresses of the decentralized wallets associated with a subscription, and interact with the decentralized wallets associated with the identifiers or addresses to cause the decentralized wallets to pay in accordance with the subscriptions of the decentralized wallets. The electronic transaction protocol can cause payment by the decentralized wallets by transmitting a payment request to the decentralized wallets or by transmitting a message to the decentralized wallets that trigger the decentralized wallets to automatically pay for the subscription in accordance with a setting or permissions of the electronic transaction protocol to automatically trigger such payments. Accordingly, the analytics server 110a can configure the electronic transaction protocols to, upon execution by the computers 120, manage subscriptions to services provided by different service providers.

The analytics server 110a can generate anonymized identifiers for the decentralized wallets of subscribers. For example, upon transmitting a message to the computer 120 and/or the server 140 to create subscription for a decentralized wallet, the analytics server 110a can generate an anonymized identifier for the decentralized wallet. The server 140 can do so using a random number generator or by executing a function (e.g., a hashing function or any other function) on the identifier of the decentralized wallet. The analytics server 110a can store a link (e.g., a stored association) between the anonymized identifier and the actual identifier for the decentralized wallet. The analytics server 110a can transmit the anonymized identifier to the server of the service provider of the subscription with the message to create the subscription without transmitting the actual identifier of the decentralized wallet to the server to create and maintain the subscription.

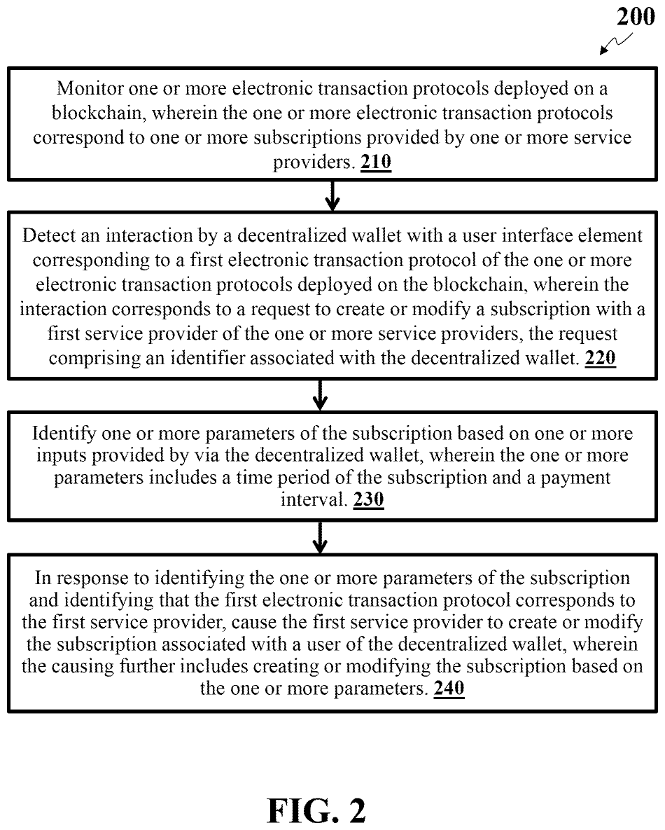

FIG. 2 illustrates a flow diagram of a method 200 executed in a blockchain-based subscription management system, according to an embodiment. The method 200 includes steps 210-240. However, other embodiments may include additional or alternative execution steps, or may omit one or more steps altogether. The method 200 is described as being executed by a server (e.g., a first system), similar to or the same as the analytics server described in FIG. 1. However, one or more steps of method 200 may also be executed by any number of computing devices operating in the distributed computing system described in FIG. 1. For instance, one or more computing devices (e.g., end-user devices) may locally perform part or all of the steps described with respect to FIG. 2.

Using the methods and systems described herein, such as the method 200, the analytics server may monitor electronic transaction protocols deployed onto a blockchain for interactions. The analytics server can create or modify subscriptions to services provided by service providers of the electronic transaction protocols based on interactions between users and the electronic transaction protocols.

At step 210, the analytics server may monitor one or more electronic transaction protocols deployed onto a blockchain. In one or more embodiments, the one or more electronic transaction protocols are one or more smart contracts deployed on a blockchain. The one or more electronic transaction protocols can correspond to one or more subscriptions provided by one or more service providers. The blockchain can be maintained by computers (e.g., not including the analytics server) of a third-party service provider (e.g., Ethereum, Tron, Ripple, Stella, Solana, Polkadot, etc.). The blockchain can include one or more block instances indicating different transactions performed on the blockchain.

The analytics server can deploy electronic transaction protocols, such as one or more smart contracts, onto the blockchain. For example, the analytics server can write or generate a request that includes parameters or terms for an electronic transaction protocol. The analytics server can transmit the request to the computers maintaining the blockchain. The computers can receive the request and append one or more block instances to the blockchain that include the parameters or terms for the electronic transaction protocol. The analytics server can similarly generate or write any number of electronic transaction protocols onto the blockchain. In this way, the analytics server can cause electronic transaction protocols to be written to a blockchain maintained by third-party computers. The analytics server can monitor electronic transaction protocols that the analytics server deployed or electronic transaction protocols that the analytics server did not deploy.

The analytics server can write conditions into electronic transaction protocols, such as one or more smart contracts, that the analytics server deploys onto the blockchain. The conditions can be triggers or “if-then” statements within the electronic transaction protocols that can be satisfied. The computers maintaining the blockchain can monitor the conditions of the electronic transaction protocol to determine whether the conditions have been satisfied. Upon determining the conditions of the electronic transaction protocol are satisfied, the computers can execute the electronic transaction protocol to complete a transaction associated with the electronic transaction protocol, such as by appending or writing a block to the blockchain containing data for the completed transaction. One example of such a condition can include a time interval (e.g., a condition that is satisfied every defined time period). The time interval can be a payment interval that causes the electronic transaction protocol to cause a payment from one wallet linked with the electronic transaction protocol to another wallet linked with the electronic transaction protocol.

The one or more electronic transaction protocols can correspond to one or more subscriptions. The one or more subscriptions can be provided by one or more service providers. For example, the analytics server can deploy an electronic transaction protocol onto the blockchain for a service provider. The analytics server may do so, for example, responsive to receiving a request containing terms and/or parameters for the electronic transaction protocol and an indication to append the electronic transaction protocol to the blockchain. The electronic transaction protocol can correspond to a subscription because the electronic transaction protocol contains a condition that causes an automatic payment from a decentralized wallet of a subscriber to a decentralized wallet of the service provider (e.g., an automatic payment at set time intervals). The service provider can provide a service (e.g., content in a software-as-a-service application) to the subscriber. The automatic payment can be a single payment or a payment at a payment interval (e.g., every day, week, month, year, etc.). In some cases, the electronic transaction protocol can include a time period for the subscription (e.g., the payment interval only lasts until the end of the time period). The computers maintaining the blockchain can execute the electronic transaction protocol upon determining satisfaction of the condition (e.g., the payment interval) until determining the time period has lapsed. Individual service providers can request for one or more electronic transaction protocols for subscriptions (e.g., subscriptions with different parameters, such as subscriptions of different levels, payment intervals, payment amounts, etc.), and the analytics server can deploy the requested electronic transaction protocols according to the requests. The analytics server can deploy any number of electronic transaction protocols. The analytics server can deploy electronic transaction protocols for any number of service providers.

The analytics server can monitor the electronic transaction protocols. The analytics server can do so by polling the computers that maintain the blockchain containing the electronic transaction protocols. For example, after transmitting the request to write the electronic transaction protocol onto the blockchain, the analytics server can poll (e.g., transmit messages to) the computers that maintain the blockchain for status updates of any users that have interacted with the electronic transaction protocol. The analytics server can do so at set or pseudo-random intervals. The computers can query the electronic transaction protocol in response to the request and the identifier of the electronic transaction protocol. The computers can transmit back a message indicating any inputs or interactions, if any, into the electronic transaction protocol. In another example, the computers can automatically query the electronic transaction protocol (e.g., query at set intervals) for any changes or interactions and transmit messages to the analytics server indicating any changes or interactions for each query. In another example, the computers can detect any changes or interactions with the electronic transaction protocol when they occur and automatically transmit the changes or interactions upon detecting the changes or interactions.

The analytics server can also monitor the electronic transaction protocol by configuring the computers to transmit messages of any interactions with the electronic transaction protocol to the analytics server. For example, the analytics server can include a flag indicating to automatically transmit changes or interactions with an electronic transaction protocol in a message the analytics server transmits to the computers to write the electronic transaction protocol. The flag can be or include an indication to transmit the changes or interactions at set time intervals or upon detecting the interactions. The computers can identify the flag and operate to transmit the changes or interactions according to the detected interactions. The analytics server can send such flags for any number of electronic transaction protocols.

At step 220, the analytics server can detect an interaction by a decentralized wallet with an electronic transaction protocol (e.g., a first electronic transaction protocol). The electronic transaction protocol can be a smart contract. The interaction can be an interaction by the decentralized wallet accessing the electronic transaction protocol. The decentralized wallet can be executed or processed by a computer. For example, the decentralized wallet can establish a connection with the computers that maintain the blockchain on which the electronic transaction protocol is stored. The computers can transmit a user interface to the decentralized wallet containing the electronic transaction protocol (e.g., the terms and/or parameters of the electronic transaction protocol). The decentralized wallet can display the electronic transaction protocol onto the computer executing or processing the decentralized wallet. The decentralized wallet can display the electronic transaction protocol in or with one or more user interface elements (e.g., forms or other interactable elements on a browser or other application) on the computer executing or processing the decentralized wallet. Such interactions can include requests to change or modify the electronic transaction protocol.

In one example, an interaction with an electronic transaction protocol can be or include a request to create or modify a subscription with a service provider associated with the electronic transaction protocol (e.g., a service provider that requested for the analytics server to deploy the electronic transaction protocol onto the blockchain). Through a user's decentralized wallet, the user can interact with user interface elements associated with the electronic transaction protocol. The interaction can be to transmit a request to the computers maintaining the electronic transaction protocol to create or modify a subscription with the electronic transaction protocol (e.g., with the service provider associated with the electronic transaction protocol). The request can include an identifier (e.g., a unique identifier, a key (e.g., a public key), an address, etc.) for or associated with the decentralized wallet. The request can indicate a request for the decentralized wallet to enter into a subscription with the service provider or to modify a subscription (e.g., modify terms or parameters of the subscription) that the decentralized wallet has already entered into with the service provider. A user can create and/or transmit the request to the computers maintaining the blockchain by providing inputs into or selecting the user interface elements.

The analytics server can detect the interaction by the decentralized wallet with the user interface element. The analytics server can detect the interaction based on the analytics server's monitoring of the electronic transaction protocol, as described with reference to step 210. For example, the analytics server can detect the interaction by the decentralized wallet with the electronic transaction protocol by polling the computers maintaining the blockchain or automatically from the computers maintaining the blockchain in a message. The interaction can be or correspond to a request to create or modify a subscription with the service provider associated with the electronic transaction protocol. The message can contain a request to create or modify a subscription between the decentralized wallet and the service provider associated with the electronic transaction protocol, an identifier of the decentralized wallet, and one or more parameters (e.g., a time period of the subscription (e.g., the requested subscription), a payment interval, a level of the subscription, etc.) for the subscription. The data in the request can be inputs by the user when interacting with the electronic transaction protocol through the decentralized wallet.

At step 230, the analytics server can identify one or more parameters of the subscription. The one or more parameters of the subscription can be parameters input by the user when interacting with the electronic transaction protocol (e.g., smart contract) via the decentralized wallet. In one example, the parameters can include or indicate how long the subscription will last (e.g., a time period of the subscription, such as a day, a week, a month, a year, indefinitely, etc.). In another example, the parameters can include or indicate a payment interval (e.g., a time period indicating intervals of time the user is to pay for the subscription, such as a day, a week, a month, a year, etc.). In another example, the parameters can include or indicate a level of the subscription. A subscription can have different tiers or levels indicating the amount or type of content or service the subscription will provide. In one example, a video streaming service can offer different types or amounts of videos for a subscription depending on the level for the subscription. In another example, the parameters can include or indicate a payment or cost for the subscription indicating how much or an amount the user is to pay at each payment interval. The payment or cost can correspond to a level for the subscription, if any. For example, the payment amount for one level can be lower or higher than the payment amount for another level of the subscription. The parameters can indicate any aspect of the subscription.

The analytics server can identify the one or more parameters and/or the service provider that corresponds to the subscription associated with the electronic transaction protocol by monitoring the electronic transaction protocol. The analytics server can do so by monitoring interactions (e.g., user interactions via decentralized wallets) with the electronic transaction protocol and identifying the service provider based on the interactions. For example, the analytics server can monitor an electronic transaction protocol using a blockchain explorer (e.g., Etherscan) or another monitoring tool, such as a contract monitor that allows the analytics server to track specific events emitted by the electronic transaction protocol and receive notifications. Based on the monitoring, the analytics server can receive and/or identify an identifier of the decentralized wallet through which the interaction was received, an identifier (e.g., a hash value) of the electronic transaction protocol, and/or any parameters for a subscription to be generated based on the interaction.

The analytics server can identify the service provider associated with the subscription based on the identifier of the electronic transaction protocol that the analytics server receives or identifies through monitoring the electronic transaction protocol. For example, the analytics server can store a table that includes electronic transaction protocol identifier-service provider identifier pairs maintained by the analytics server in memory. The analytics server can compare the identifier of the electronic transaction protocol to the identifiers (e.g., electronic transaction protocol identifiers) in the table. The analytics server can identify the service provider based on a match between the electronic transaction protocol identifier from the interaction and an identifier in the table. The analytics server can identify the identifier of the service provider linked with the matching identifier in the table. In some cases, identifying the service provider can include identifying a profile or data structure in memory that includes contact information (e.g., an Internet Protocol (IP) address, an email address, a mailing address, etc.) for the service provider.

In some embodiments, the computers maintaining the blockchain can transmit a message to the analytics server that includes an identifier of the electronic transaction protocol (e.g., a numerical or alphanumerical value) associated with the interaction and/or the service provider associated with the electronic transaction protocol and/or the one or more parameters for the subscription. The analytics server can identify the one or more parameters and/or the service provider that corresponds to the electronic transaction protocol by identifying the one or more parameters and/or the identifier of the service provider from the message. In instances in which the message does not contain an identifier of the service provider and only includes an identifier of the electronic transaction protocol, the analytics server can identify the identifier of the electronic transaction protocol from the message and compare the identifier with electronic transaction protocol identifiers in a table that includes electronic transaction protocol identifier-service provider identifier pairs maintained by the analytics server in memory, as described above.

At step 240, the analytics server can cause the service provider to create or modify the subscription. The subscription can be associated with a user of the decentralized wallet through which the subscription was created. For example, the analytics server can transmit a message to a computer or server of the service provider. The message can include the parameters (e.g., the time period, the payment interval, the price, and/or the payment level of the subscription) for the subscription and an identifier of the user. The identifier of the user can be the identifier associated with the decentralized wallet of the user.

In some cases, the analytics server can transmit a generated identifier of the decentralized wallet to the computer or server of the service provider. For example, the analytics server can generate (e.g., pseudo-randomly generate) an anonymized identifier for the decentralized wallet. The analytics server can generate the anonymized identifiers for each of the decentralized wallets upon detecting a first request to generate a subscription for the decentralized wallet. The analytics server can generate the anonymized identifiers by using a random number generator or by performing a calculation (e.g., a hash algorithm) on the identifiers of the decentralized wallets. The analytics server can generate the identifier and store the generated identifier in a table (e.g., a look-up table that can contain a mapping of anonymized identifiers to identifiers of decentralized wallets).with a stored association with the identifier of the decentralized wallet of the user. The analytics server can transmit the anonymized identifier to the computer or servers of service provider to create or modify the subscription instead of the identifiers of the decentralized wallet. The analytics server can transmit such anonymized identifiers instead of the identifiers (e.g., addresses or public keys) of decentralized wallets to computers or server of service providers. In this way, the analytics server can reduce the amount of personal information that is transmitted over a network or to different computers (e.g., the service providers may only receive the anonymized identifier of the decentralized wallet, not any other PII).

The computer or server of the service provider can receive the message from the analytics server and generate a subscription for the user. The subscription can be a profile or record of the user that the service provider maintains that indicates the user is a current subscriber with the service provider and/or any parameters of the subscription. The computer or server can receive the message for the subscription of the user and generate a record for the subscription to store in a database. The record can include the identifier of the user from the message and/or the parameters of the subscription (e.g., payment intervals, level, time period of the subscription, etc.). In this way, the computer or server can generate or create a subscription for a user based on the user's interaction with an electronic transaction protocol (e.g., smart contract) stored on the blockchain.

In some cases, the user can generate a request to modify a subscription. For example, the user may have already generated the subscription as described above, but then wish to change the parameters of the subscription (e.g., change a level of the subscription). To do so, the user can access the electronic transaction protocol of the service provider associated with the subscription and input parameters to change or modify the subscription. The analytics server can detect the inputs in a request (e.g., a second request) to modify the subscription and transmit a message to the computer or server of the service provider associated with the subscription indicating the input modifications as well as the identifier associated with the user and the subscription. The computer or server can receive the message. The computer or server can identify the profile or record associated with the subscription based on the identifier associated with the user in the message from the analytics server. The computer or server can then modify the subscription for the user according to the modification in the message. Accordingly, the analytics server can facilitate creation and changes of subscriptions created through an electronic transaction protocol.

In addition to or instead of transmitting a message to cause creation of a subscription for the user at the service provider, the analytics server can cause creation of the subscription by causing a transaction block to be written onto the blockchain that indicates the subscription. For example, responsive to detecting the subscription, the analytics server can transmit a message to the computers maintaining the blockchain indicating to create a subscription for the user. The message can contain the parameters of the subscription as input by the user as well as the identifier of the decentralized wallet. The message can contain an identifier of the electronic transaction protocol with which the user interacted and/or the service provider associated with the electronic transaction protocol. The computers maintaining the electronic transaction protocol can receive the message and append or write a block instance to the blockchain containing the parameters for the subscription, the identifier of the electronic transaction protocol associated with the subscription, the identifier of the service provider, and/or the identifier of the decentralized wallet.

The service provider associated with the subscription can monitor the blockchain for block instances that indicate created subscriptions. The service provider can create records in memory for subscriptions for any identified block instances based on the data (e.g., parameters) in the respective identified block instances. Thus the service provider can create subscriptions without receiving direct messages from the analytics server, in some cases.

The analytics server can similarly cause a modification of the subscription on the blockchain. For example, responsive to detecting a modification to the subscription, the analytics server can transmit a message to the computers maintaining the blockchain indicating to modify a subscription for the user. The message can contain the new parameters (e.g., the modified parameters) of the subscription as input by the user as well as the identifier of the decentralized wallet. The message can contain an identifier of the electronic transaction protocol with which the user interacted and/or the service provider associated with the electronic transaction protocol. The computers maintaining the electronic transaction protocol can receive the message and append or write a block instance to the blockchain containing the modified parameters for the subscription, an identifier of the electronic transaction protocol associated with the subscription, the identifier of the service provider, and/or the identifier of the decentralized wallet. The service provider can identify the modification to the subscription from the block instance by monitoring the blockchain as described above and update the record for the subscription according to the modification in the block instance.

A subscription with a service provider can be any type of subscription. In one example, the subscription can be a subscription for content provided by the service provider. Such content can include videos, websites, access to an application, websites, access to blogs, etc. The subscriptions can be associated with accounts maintained by the service providers (e.g., identifiers of the accounts can be stored in the records for the subscriptions). Upon creating or modifying a subscription with such a service provider, a user can access an account that corresponds with the subscription and receive content from a computer or server of the service provider through the account (e.g., the computer or server of the service provider can transmit content for the subscription to the computing device at which the user has logged into an account associated with a subscription created and/or modified as described herein). Accordingly, the service provider can automatically generate subscriptions and provide content to users using the blockchain infrastructure.

In another example, a subscription can be a subscription for real-world entities or brick-and-mortar stores. Examples of such subscriptions can include a membership to a health club, a membership with a restaurant, a membership to a rewards program, or any other type of membership. The computers can communicate with the analytics server to deploy an electronic transaction protocol to the blockchain for such subscriptions and manage access to the real-world entities based on the analytics server establishing subscriptions with the entities through the blockchain infrastructure.

The blockchain infrastructure can be used to control payments for the subscriptions. For example, through the electronic transaction protocols that the analytics server deploys onto the blockchain, the analytics server can cause the decentralized wallets of the subscriptions established through the different electronic transaction protocols to pay for the subscriptions. For instance, an electronic transaction protocol can have a condition that causes the electronic transaction protocol to pull funds (e.g., tokens or dollars) from a decentralized wallet at the end of every payment interval. Upon detecting the end of the payment interval, the computers storing the electronic transaction protocol can execute the electronic transaction protocol and extract a payment from the decentralized wallet. In doing so, the electronic transaction protocol can remove one or more tokens or other unit of currency from the decentralized wallet of the subscriber. The electronic transaction protocol can identify a decentralized wallet of the service provider associated with the subscription from an identifier of the service provider's decentralized wallet in the electronic transaction protocol or a block instance associated with the electronic transaction protocol. The electronic transaction protocol can insert the one or more tokens or other unit of currency into a decentralized wallet of the service provider associated with the subscription. The electronic transaction protocol can then write a block instance for the payment or transaction onto the blockchain. The electronic transaction protocol can similarly cause payment for any number of decentralized wallets either at the same time based on each decentralized wallet having the same payment interval, or separately for each decentralized wallet depending on the payment interval of the decentralized wallet.

In one example, the electronic transaction protocol can determine a condition is satisfied for a particular decentralized wallet, identify the block instance that includes the transaction data of the subscription for the decentralized wallet. The electronic transaction protocol can identify the payment amount (which may correspond to a particular level for the subscription) for the subscription from the block instance, and retrieve the payment amount for the subscription from the decentralized wallet.

In some cases, a service provider may not own or otherwise be associated with a decentralized wallet. In such cases, the analytics server can receive payments through a decentralized wallet owned by the analytics server. For example, upon the electronic transaction protocol initiating a payment for a subscription with a decentralized wallet, the analytics server can insert the tokens or other unit of currency into a decentralized wallet of the analytics server. The analytics server can then transmit an amount of currency equal to the currency received from the subscriber to an account (e.g., a bank account) of the service provider, thus enabling service providers to use the blockchain infrastructure without owning a decentralized wallet.

In some cases, instead of automatically retrieving/pulling a payment for a subscription to a decentralized wallet, the electronic transaction protocol (e.g., smart contract) can transmit a payment request to a decentralized wallet. For example, upon determining a payment interval has ended for a subscription by a decentralized wallet, the electronic transaction protocol can transmit a payment request to the decentralized wallet indicating an amount due and/or a time period for payment. The decentralized wallet can receive the payment request and present a user interface associated with the payment request on a display of a computing device. A user accessing the computing device can select an option to approve or reject the payment. The decentralized wallet can transmit the user's selection to the computers maintaining the blockchain and electronic transaction protocol (e.g., transmit the user's selection to the electronic transaction protocol). Responsive to receiving an approval (e.g., a selection of an authorization or approval for the payment), the electronic transaction protocol can retrieve one or more tokens or other unit of currency from the decentralized wallet and pay the service provider as described herein. The electronic transaction protocol can append a block instance to the blockchain by writing the transaction to the blockchain. Responsive to receiving a rejection of the payment, the electronic transaction protocol can transmit a message to the analytics server indicating the rejection and the analytics server can transmit a message to the computer or server of the service provider indicating the rejection. The service provider can update the subscription for the decentralized wallet to indicate the rejection and, in some instances, stop providing content or other services to the user of the decentralized wallet accordingly.

In some cases, in addition to or instead of creating or modifying subscriptions for a service provider through an electronic transaction protocol, users can revoke subscriptions through the electronic transaction protocol. For example, a user can interact with an electronic transaction protocol through which the user has previously created a subscription (e.g., created a subscription using the systems and methods described herein). The user can select or otherwise provide an input at a user interface element of the electronic transaction protocol that corresponds to a revocation of the subscription. The analytics server can monitor the electronic transaction protocol and detect the revocation input. Responsive to detecting the revocation input, the analytics server can transmit a message to a computer or server of the service provider indicating the revocation of the subscription. The message can include an identifier of the revocation as well as an identifier of the decentralized wallet that was used to access the electronic transaction protocol for the revocation. The computer or server of the service provider can receive the message for the revocation and remove the subscription from memory or otherwise update the subscription to indicate the revocation. The service provider can then stop providing content (e.g., content through a computer server) to an account associated with the subscription or otherwise any other benefits of the subscription to the user of the decentralized wallet.

In addition or instead of transmitting a message to the service provider to revoke the subscription, the analytics server can cause a block instance to be written to the blockchain to indicate the revocation of the subscription. For example, the analytics server can transmit a message to the computers maintaining the blockchain that includes an indication of the revocation of the subscription, an identifier of the decentralized wallet, an identifier of the electronic transaction protocol associated with the revoked subscription, and/or an identifier of the service provider associated with the revoked subscription. The computers can receive the message and append a block instance to the blockchain indicating the revoked subscription (e.g., a block instance that revokes access to the decentralized wallet associated with the revoked subscription). In some instances, when the electronic transaction protocol for the subscription executes to cause payment for subscriptions for the electronic transaction protocol, the electronic transaction protocol can identify the block instance for the revoked subscription and not collect payment from the decentralized wallet identified in the block instance.

In some embodiments, the analytics server may not transmit a message to the service provider when revoking a subscription. In such embodiments, the service provider may monitor the blockchain for new block instances that indicate revocations to subscriptions that correspond to the service provider. For example, the analytics server can cause a block instance to be written to the blockchain that revokes access to a decentralized wallet. The block instance can include an indication of the revocation of the subscription, an identifier of the decentralized wallet associated with the revoked subscription, an identifier of the electronic transaction protocol (e.g., smart contract) associated with the revoked subscription, and/or an identifier of the service provider associated with the revoked subscription. The service provider (e.g., via a server or computer of the service provider) associated with the subscription (and other service providers that are associated with subscriptions maintained by the blockchain) can monitor the blockchain for new transactions or new block instances appended to the blockchain that contain an identifier of the service provider and an indication of a subscription revocation and/or cancellation. The service provider can identify the block instance that contains the indication of the revocation of the subscription based on the identifier of the service provider in the block instance. The service provider can identify the identifier of the decentralized wallet in the block instance and update the database maintained by the service provider to indicate the subscription for the decentralized wallet has been canceled or revoked.

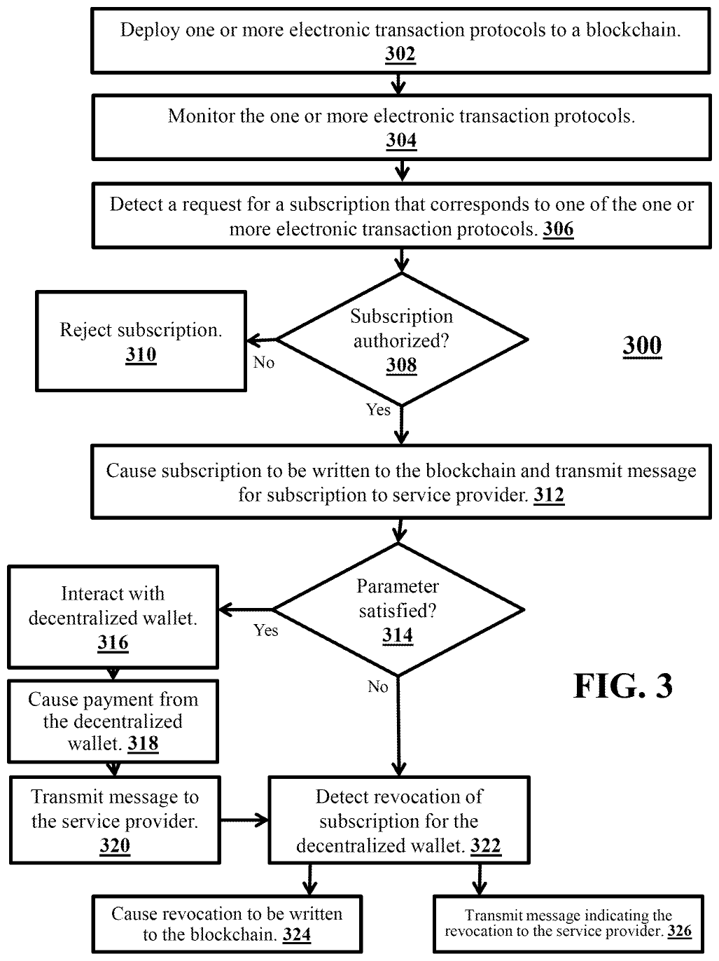

FIG. 3 illustrates a flow diagram of a method 300 executed in a blockchain-based subscription management system, according to an embodiment. The method 300 can be performed at the same time or in conjunction with the method 200. The method 300 includes steps 302-328. However, other embodiments may include additional or alternative execution steps, or may omit one or more steps altogether. The method 300 is described as being executed by a server, similar to or the same as the analytics server described in FIG. 1. However, one or more steps of method 300 may also be executed by any number of computing devices operating in the distributed computing system described in FIG. 1. Using the methods and systems described herein, such as the method 300, the analytics server may monitor and manage subscriptions generated through electronic transaction protocols deployed onto a blockchain.

At step 302, the analytics server can deploy one or more electronic transaction protocols (e.g., one or more smart contracts). The analytics server can deploy the one or more electronic transaction protocols to a blockchain maintained by one or more computers. The analytics server can deploy each of the one or more electronic transaction protocols in response to receiving requests from service providers that include parameters and/or terms for the electronic transaction protocols. The analytics server can deploy the electronic transaction protocols by transmitting messages to the computers maintaining the electronic transaction protocols indicating the terms (e.g., conditions) and/or parameters of the respective electronic transaction protocols. The computers can receive the messages and append one or more block instances for each of the electronic transaction protocols to the blockchain to store and maintain the electronic transaction protocols.

At step 304, the analytics server can monitor the one or more electronic transaction protocols (e.g., one or more smart contracts). The analytics server can monitor the one or more electronic transaction protocols by polling or receiving automatic updates from the computers that are maintaining the blockchain. At step 306, the analytics server can detect a request for a subscription that corresponds to an electronic transaction protocol (e.g., a smart contract). The analytics server can detect the request for the subscription based on the analytics server monitoring the electronic transaction protocol. A user can access a user interface containing the electronic transaction protocol or other user interface elements associated with the electronic transaction protocol via a user interface provided by a decentralized wallet of the user. The user can interact with the electronic transaction protocol or the user interface elements through the user interface. The interaction may be a request to create or modify a subscription with a service provider for which the electronic transaction protocol was deployed. The request can also include parameters for the subscription as input or otherwise selected by the user. The analytics server can receive a message from the computers indicating the request to create or modify the subscription with an identifier of the decentralized wallet through which the request was generated.

At step 308, the analytics server can determine if the subscription is authorized. For example, upon the user interacting with the user interface elements of the electronic transaction protocol (e.g., smart contract), the computers maintaining the blockchain can transmit a message to the decentralized wallet containing an authorization request. The authorization request can include a user interface element requesting whether the user authorizes the decentralized wallet to enter into or modify the subscription of the request to create or modify the subscription. The user can select an option to authorize or reject the request by selecting an option to authorize or reject the request. The computers can receive the selection and transmit the selection to the analytics server. The analytics server can identify the selection. Responsive to determining the selection was to reject the subscription, at step 310, the analytics server can reject the subscription (e.g., not transmit any messages or perform any actions to create the subscription).

However, responsive to determining the selection is to authorize the subscription, at operation 312, the analytics server can cause the subscription to be written to the blockchain. For example, the analytics server can transmit a message to the computers maintaining the blockchain to write a transaction (e.g., a transaction to create the requested subscription) to the blockchain. The message can contain the parameters for the subscription input or otherwise selected by the user and/or an identifier (e.g., an anonymized identifier or a public key) of the decentralized wallet. The computers can receive the message and append a block instance for the subscription to the blockchain that contains the parameters and/or the identifier of the decentralized wallet.

In some embodiments, the analytics server can transmit a message for the subscription to a service provider (e.g., the service provider associated with the electronic transaction protocol (e.g., smart contract) through which the subscription is being created). The analytics server can transmit the message to a computer or server owned or otherwise associated with the service provider. The message can contain the parameters for the subscription input or otherwise selected by the user and/or the identifier of the decentralized wallet. The computer or server can receive the message and, in the case of a request to create a subscription, generate a record including the identifier of the decentralized wallet and/or parameters for the subscription. In the case of a request to modify a subscription, the computer or server can identify a subscription that has already been stored in the decentralized wallet based on the identifier of the decentralized wallet and update the subscription with the new modified parameters included in the message.

The analytics server can cause the subscription to be written to the blockchain regardless of whether the analytics server transmits a message for the subscription to a service provider. For example, the analytics server can transmit a message for the subscription to the service provider to inform the service provider of the subscription or the service provider can monitor the blockchain for block instances that identify the service provider or a smart contract deployed for the service provider. The service provider can monitor the blockchain for a subscription block instance that was written for a subscription for the service provider. Accordingly, the analytics server can cause a subscription to be written to the blockchain in each case while the analytics server may or may not notify the service provider of the subscription with a message.

At step 314, the analytics server can determine whether a parameter is satisfied. The parameter can be a payment interval for the decentralized wallet. The analytics server can determine whether the parameter is satisfied via the electronic transaction protocol (e.g., smart contract) associated with the subscription that the analytics server deployed onto the blockchain. For example, the computers, in some cases by executing the electronic transaction protocol, that maintain the blockchain can maintain a clock and/or a calendar. The computers can increment the clock and/or calendar over time. Subsequent to incrementing the clock or calendar, the computers can compare the incremented clock or calendar to the payment interval for the subscription of the decentralized wallet (e.g., the payment interval that is identified in the block instance for the subscription of the decentralized wallet on the blockchain). The computers can determine the payment interval is satisfied responsive to determining the incremented clock and/or calendar has reached the end of the payment interval, otherwise, the computers can determine the payment interval is not satisfied.

Responsive to determining the parameter for the decentralized wallet is satisfied, at step 316, the computers (e.g., through the electronic transaction protocol (e.g., smart contract) deployed by the analytics server) can interact with the decentralized wallet. The computers can interact with the decentralized wallet by transmitting a message to the decentralized wallet. The message can cause the decentralized wallet to automatically submit a payment for the electronic transaction protocol or to display a message requesting approval for the payment from the user of the decentralized wallet. The payment can be for a payment amount parameter for the subscription.

Either automatically or upon receipt of approval for the payment, at step 318, the computers can cause payment in accordance with the payment amount from the decentralized wallet. The payment can be a payment to a decentralized wallet of the service provider associated with the subscription or a payment to a decentralized wallet of the analytics server.

At step 320, the analytics server can transmit a message to the computer or server of the service provider indicating the payment. The computer or server of the service provider can receive the message and update the record indicating the subscription for the decentralized wallet to indicate the payment.

At step 322, the analytics server can detect a revocation of the subscription for the decentralized wallet. The analytics server can detect the revocation by monitoring the electronic transaction protocol (e.g., smart contract) associated with the subscription. The analytics server can detect an interaction by the user of the decentralized wallet through the decentralized wallet and with the electronic transaction protocol. The interaction may be an input or selection to revoke the subscription. The analytics server can receive the input or selection to revoke the subscription from the computers maintaining the blockchain in a message containing the input or selection and the identifier of the decentralized wallet.

At step 324, the analytics server can cause the revocation of the subscription to be written to the blockchain. The analytics server can cause the revocation of the subscription to be written to the blockchain by transmitting a message to the computers maintaining the blockchain indicating to revoke the subscription. The message can include the identifier of the decentralized wallet and an indication to revoke the subscription. The computers can receive the message and append a block instance to the blockchain indicating the transaction to revoke the subscription for the decentralized wallet. The block instance can contain an indication of the revocation as well as the identifier of the decentralized wallet.

At step 326, the analytics server can transmit a message to the computer or server of the service provider indicating the revocation. The message can contain the identifier of the decentralized wallet as well as an indication to revoke the subscription. The computer or server can receive the message and automatically update the subscription to revoke the subscription. For example, the computer or server can identify the record containing the subscription for the decentralized wallet based on the identifier in the message. The computer or server can then either remove the record from memory or update the record to indicate the subscription is no longer valid.

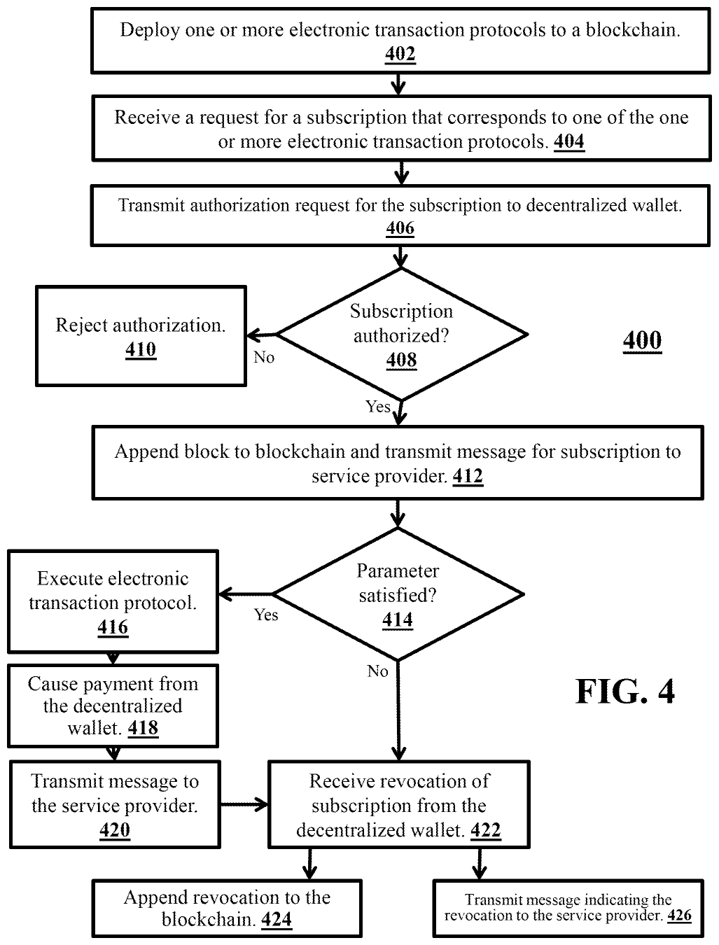

FIG. 4 illustrates a flow diagram of a process executed in a blockchain-based subscription management system, according to an embodiment. The method 400 includes steps 402-428. However, other embodiments may include additional or alternative execution steps, or may omit one or more steps altogether. The method 400 is described as being executed by a server, similar to the analytics server described in FIG. 1. However, one or more steps of method 400 may also be executed by any number of computing devices operating in the distributed computing system described in FIG. 1. Using the methods and systems described herein, such as the method 400, the analytics server may maintain a blockchain that stores and electronic transaction protocols (e.g., smart contracts) for managing subscriptions to services provided by service providers.

At step 402, the analytics server can deploy one or more electronic transaction protocols (e.g., smart contracts). The analytics server can be a server or computer that manages a blockchain with one or more other computers. The analytics server can be a single computer of the computers that maintain the blockchain. The analytics server can deploy the one or more electronic transaction protocols to the blockchain maintained by the analytics server and the one or more other computers. The analytics server can deploy each of the individual one or more electronic transaction protocols in response to receiving requests from service providers (e.g., from computers or servers of the service providers) that include parameters and/or terms for the electronic transaction protocols. The analytics server can deploy the electronic transaction protocols by establishing a consensus or quorum with the other computers maintaining the blockchain to deploy the electronic transaction protocols onto the blockchain in one or more block instances. Each smart contact can include terms (e.g., conditions) and/or parameters that were included in the requests to deploy (e.g., append) the electronic transaction protocols from the service providers.

At step 404, the analytics server can receive a request to create or modify a subscription associated with an electronic transaction protocol (e.g., a smart contract) associated with a service provider. The request can be a request to create or modify a subscription for a decentralized wallet. The subscription can be associated with an electronic transaction protocol. In one example, the analytics server can receive the request from the decentralized wallet through a user interface provided by the decentralized wallet that gives access to the user of the decentralized wallet to the electronic transaction protocol. The analytics server can detect the interaction with the electronic transaction protocol by the user as a request to create or modify a subscription for a service provided by the service provider associated with the electronic transaction protocol. The request can include one or more parameters for the subscription, such as a payment interval, a period for the subscription, an amount to pay per payment period, or a level for the subscription. The request can also include an identifier of the decentralized wallet through which the user input the request to create or modify the subscription.

In another example, the analytics server can receive the request to create or modify a subscription from a browser application executing on a computing device. For example, a user accessing such a computing device can go to a website of a service provider. At the website, the user can select an option to subscribe to a subscription provided by the service provider using the user's decentralized wallet. The user can input an identifier (e.g., an address or other identifier) of the decentralized wallet into a form of the website as well as any other parameters for the subscription and select a “submit” or “subscribe” button to subscribe to the services provided by the service provider. In some cases, the forms and/or locations for such input can be at locations of the websites partitioned from the servers of the website owners to maintain the privacy of the subscriber. The analytics server can receive the request to create the subscription or to modify the subscription with the parameters and/or the identifier of the decentralized wallet from the browser application.

At step 406, the analytics server can transmit an authorization request for the subscription to the decentralized wallet. The analytics server can identify the address of the decentralized wallet from the input identifier of the decentralized wallet. The analytics server can transmit a message to the decentralized wallet based on the address of the decentralized wallet. The message can include an option to authorize or reject the subscription requested at the website of the service provider.

At step 408, the analytics server can determine if the subscription is authorized. For example, upon receiving the rejection or authorization selection from the browser, the analytics server can identify the selection. Responsive to determining the selection was to reject the subscription, at step 410, the analytics server can reject the subscription (e.g., not transmit any messages or perform any actions to create the subscription).

However, responsive to determining the selection is to authorize the subscription, at operation 412, the analytics server can write or append (e.g., cause to be written or appended) the subscription to the blockchain. For example, the analytics server can write a block instance to the blockchain maintained by the analytics server that contains parameters for the subscription and/or the identifier (in some cases an anonymized identifier, as described above) of the decentralized wallet.

In some embodiments, the analytics server can transmit a message for the subscription to a service provider (e.g., the service provider associated with the electronic transaction protocol (e.g., smart contract) through which the subscription is being created). The analytics server can transmit the message to a computer or server owned or otherwise associated with the service provider. The message can contain the parameters for the subscription input or otherwise selected by the user and/or the identifier of the decentralized wallet. The computer or server can receive the message and, in the case of a request to create a subscription, generate a record including the identifier of the decentralized wallet and/or parameters for the subscription. In the case of a request to modify a subscription, the computer or server can identify a subscription that has already been stored or the decentralized wallet based on the identifier of the decentralized wallet and update the subscription with the new modified parameters included in the message.

The analytics server can write or append the subscription to the blockchain regardless of whether the analytics server transmits a message for the subscription to a service provider. For example, the analytics server can transmit a message for a subscription to a service provider to inform the service provider of the subscription or the service provider can monitor the blockchain for block instances that identify the service provider or a smart contract deployed for the service provider. The service provider can monitor the blockchain for a subscription block instance that was written for a subscription for the service provider. Accordingly, the analytics server can cause a subscription to be written to the blockchain in each case while the analytics server may or may not notify the service provider of the subscription with a message.

At step 414, the analytics server can determine whether a parameter is satisfied. The parameter can be a payment interval for a decentralized wallet. The analytics server can determine whether the parameter is satisfied via the electronic transaction protocol (e.g., smart contract) associated with the subscription that the analytics server deployed onto the blockchain. For example, the analytics server, in some cases by executing the electronic transaction protocol, can maintain a clock and/or a calendar. The analytics server can increment the clock and/or calendar over time. Subsequent to incrementing the clock or calendar, the analytics server can compare the incremented clock or calendar to the payment interval for the subscription of the decentralized wallet (e.g., the payment interval that is identified in the block instance for the subscription of the decentralized wallet on the blockchain). The analytics server can determine the payment interval is satisfied responsive to determining the incremented clock and/or calendar has reached the end of the payment interval, otherwise, the analytics server can determine the payment interval is not satisfied.

Responsive to determining the parameter for the decentralized wallet is satisfied, at step 416, the analytics server can execute the electronic transaction protocol (e.g., smart contract) associated with the subscription. In doing so, the analytics server can interact with the decentralized wallet associated with the subscription. The analytics server can interact with the decentralized wallet by transmitting a message to the decentralized wallet. The message can cause the decentralized wallet to automatically submit a payment for the electronic transaction protocol or to display a message requesting approval for the payment from the user of the decentralized wallet. The payment can be for a payment amount parameter for the subscription.

Either automatically or upon receipt of approval for the payment, at step 418, the analytics server can cause payment in accordance with the payment amount from the decentralized wallet. The payment can be a payment to a decentralized wallet of the service provider associated with the subscription or a payment to a decentralized wallet of the analytics server.

At step 420, the analytics server can transmit a message to the computer or server of the service provider indicating the payment. The computer or server of the service provider can receive the message and update the record indicating the subscription for the decentralized wallet to indicate the payment.

At step 422, the analytics server can receive a request to revoke the subscription for the decentralized wallet. The analytics server can receive the request to revoke the subscription associated with a service provider. The request can be a request to revoke the subscription for the decentralized wallet. In one example, the analytics server can receive the request from the decentralized wallet through a user interface provided by the decentralized wallet that gives access to the user of the decentralized wallet to the electronic transaction protocol (e.g., smart contract) associated with the subscription. The analytics server can detect an interaction with the electronic transaction protocol by the user as a request to revoke the subscription for the service provided by the service provider associated with the electronic transaction protocol. For example, the revocation of a subscription can be identified based on detecting the user has, via selections made in the decentralized wallet, revoked access by the electronic transaction protocol to the decentralized wallet.

In another example, the analytics server can receive the request to revoke the subscription from a browser application executing on a computing device. For example, a user accessing such a computing device can go to a website of a service provider. At the website, the user can select an option to revoke a subscription that the user previously established through the blockchain infrastructure. The user can input an identifier (e.g., an address or other identifier) of the decentralized wallet or an account associated with the subscription into a form of the website and select an option to revoke the subscription at the website. The analytics server can receive the request to revoke the subscription with the identifier of the decentralized wallet from the browser application.

At step 424, the analytics server can write or append the revocation of the subscription to the blockchain. The analytics server can write or append the revocation of the subscription in response to receiving or detecting the request to revoke the subscription. The analytics server can write the revocation of the subscription to the blockchain by appending a block instance for the revocation that includes an indication of the revocation and the identifier of the decentralized wallet.

At step 426, the analytics server can transmit a message to the computer or server of the service provider indicating the revocation. The message can contain the identifier of the decentralized wallet as well as an indication to revoke the subscription. The computer or server can receive the message and automatically update the subscription to revoke the subscription. For example, the computer or server can identify the record containing the subscription for the decentralized wallet based on the identifier in the message. The computer or server can then either remove the record from memory or update the record to indicate the subscription is no longer valid.

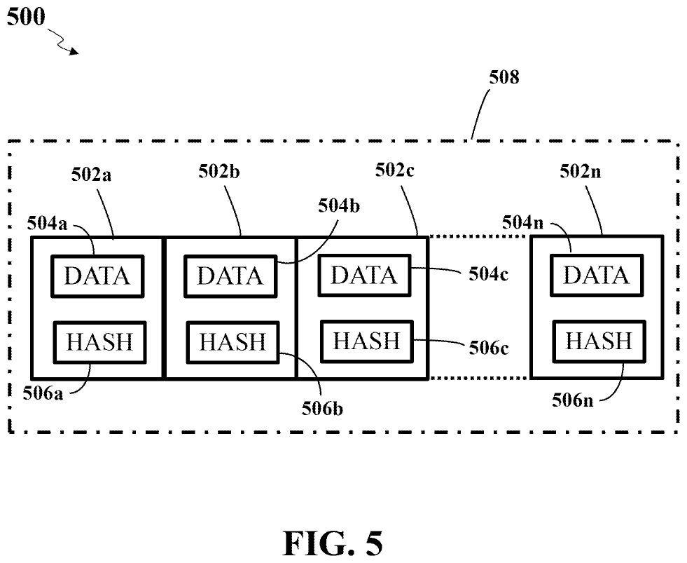

Referring now to FIG. 5, a non-limiting example of appending block instances to a blockchain comprising different block instances is illustrated. As depicted in FIG. 5, a blockchain 508 comprising block instances 502a-502n (collectively 502) may include data 504a-504n (collectively 504) that enables information, such as transaction data, hierarchical data (e.g., a hierarchy file indicating a node hierarchy of the blockchain), electronic transaction protocol data (e.g., smart contract data), machine-readable code/documents, and other metadata associated with one or more transactions of the peer nodes described above. The block instances 502 may also contain hash values 506a-506n (collectively 506) that are used to link each of the block instances to the preceding block instance.

Peer nodes (e.g., the computers 120) may generate (or instruct a blockchain service to generate) the block instance 502a (e.g., the genesis block). The peer nodes may receive data 504a from a first peer node or a first computing device via a GUI provided by an analytics server on the first computing device or peer node. For example, an administrator using the first computing device may log in to a website hosted or otherwise associated/managed by the analytics server and transmit data 504b (e.g., a transaction record) to other peer nodes. The peer nodes may verify the data 504b against data of a corresponding transaction record. Responsive to determining the data matches, the peer nodes may generate a block instance for the blockchain that they maintain. Upon generation of the block instance 502b, the peer nodes may generate the hash value 506b based on the data 504b (and/or data of the immediately previous block instance), an identifier of the first computing device, and/or other identifier information (e.g., time stamp and/or geolocation information). The identification information may be used as a veracity scale factor that the information is true and accurate.

The peer nodes may generate (or instruct a blockchain service to generate) the block instance 502c. The peer nodes may receive data 504c from a second computing device (e.g., a second peer node) via a GUI provided by the analytics server on the second computing device. For example, an administrator using the second computing device may log in to a website hosted or otherwise managed by the analytics server and the second computing device may transmit data 504c to the peer nodes. The peer nodes may generate a hash value 506c based on the data 504c and other information as described above.

The hash value 506c may be based on the hash value 506b and/or the data 504c. The peer nodes may incorporate the hash value 506b into the hash value 506c to append the block instance 502c to the block instance 502b. The peer nodes may subsequently poll all the peer nodes to ensure the highest integrity of the blockchain by appending the latest block instance to the latest valid blockchain instances (e.g., the last blockchain for which there was a quorum). Using this method, block instances within the blockchain 508 may be appended to the preceding block instance. The peer nodes may generate block instances 502c-n using the same methods explained above to continuously update the blockchain 508. As depicted, block instances 502a, 502b, 502c, and 502n are connected because of synchronization of hash values 506a, 506b, 506c, and 506n.

Modification of data within a block instance may disconnect that block instance from the blockchain. The peer nodes may use this method to combat possible fraud or unauthorized modification of the data within blockchain instances. For example, if the second administrator using the second computing device modifies data 504b within block instance 502b, the hash value 506b will also be modified. As explained above the hash value 506b may be based on (or at least partially based on) data 504b; therefore if data 504b is modified, hash value 506b will also be modified. Modification of the data 504b or the hash value 506c may break the link between block instance 502b and block instance 502c because the hash value 506c is at least in part generated based on hash value 506b.

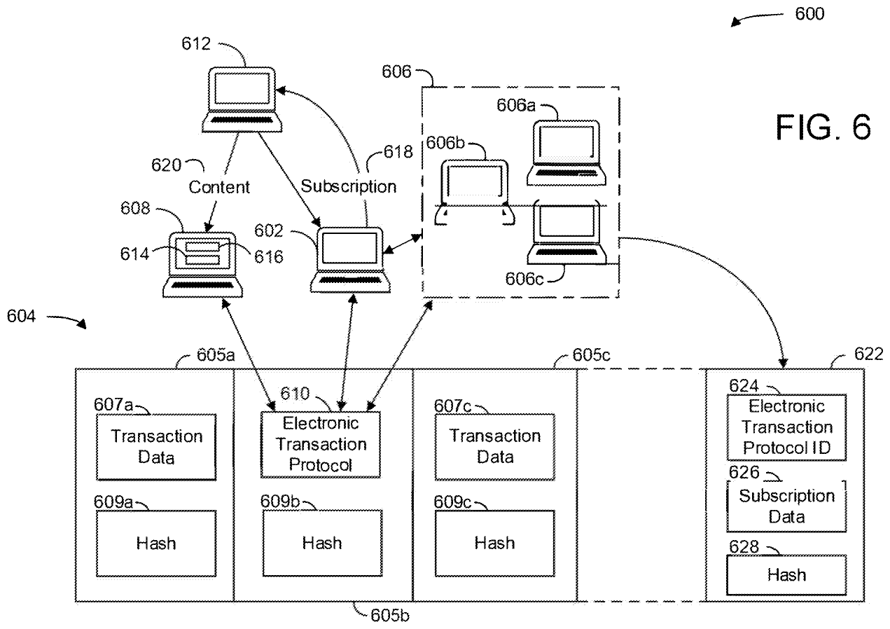

FIG. 6 visually depicts a non-limiting example of how the methods and systems described herein can be implemented. A sequence 600 may include an analytics server 602 that facilitates subscriptions between computers and service providers using electronic transaction protocols (e.g., smart contracts) of a blockchain 604 maintained by a plurality of computers 606 (e.g., computers 606a-606c). The analytics server 602 can deploy such electronic transaction protocols onto the blockchain 604 in response to receiving requests from computers or servers of service providers to deploy the electronic transaction protocols onto the blockchain 604. Such requests can include terms or conditions for the electronic transaction protocols and the analytics server 602 can include such terms or conditions in the respective electronic transaction protocols that the analytics server 602 deploys onto the blockchain 604.

A client device 608 can initiate a subscription request through an electronic transaction protocol 610 (e.g., a smart contract) of the blockchain 604. The electronic transaction protocol 610 can be an electronic transaction protocol that the analytics server 602 deploys onto the blockchain 604 in response to a request to do so from a computer 612 of a service provider. The client device 608 can execute or process a decentralized wallet 614 to access one or more user interface elements 616 (e.g., forms or terms of the electronic transaction protocol 610). The client device 608 can provide an input into the user interface elements 616 in a request for a subscription for the decentralized wallet 614 with the electronic transaction protocol 610. Such a request can include an identifier (e.g., an address or other numerical or alphanumerical identifier) of the decentralized wallet 614 and/or parameters for the subscription, such as a payment interval and/or a time period of the subscription.

The blockchain 604 can include block instances 605a-605c. The block instance 605a can include transaction data 607a for a transaction for the block instance 605a and a hash 609a. The block instance 605b can include the electronic transaction protocol 610 and a hash 609b. The block instance 605c can include transaction data 607c and a hash 609c. Each of the hashes of the blockchain 604 can be generated using a hashing function (e.g., SHA1, SHA2, SHA256, etc.) on the data of the respective block instance and the hash of the immediately previous block instance within the blockchain 604. Thus, the block instances of the blockchain 604 can be immutable.

The analytics server 602 can detect the request for the subscription. The analytics server can detect the request for the subscription by monitoring the electronic transaction protocol 610. In doing so, the analytics server 602 can detect the identifier of the decentralized wallet 614 as well as the parameters for the subscription. The analytics server 602 can identify an identifier of the electronic transaction protocol 610. The analytics server 602 can identify the computer 612 or the service provider associated with the computer 612 or electronic transaction protocol 610 based on the identifier of the electronic transaction protocol 610. The analytics server 602 can transmit a message 618 for the subscription to the computer 612. The message 618 can include the parameters for the subscription and/or an identifier of the decentralized wallet 614 (e.g., an anonymized identifier for the decentralized wallet 614 or the address or key for the decentralized wallet 614) in the message 618.

The computer 612 can create or modify a subscription according to the message 618. For example, to create a subscription for the subscription request, the computer 612 can generate a record in a database maintained by the computer 612. The record can include the identifier of the decentralized wallet 614 and the parameters for the subscription. The record can also include account information for the subscription. To modify a subscription, the computer 612 can use the identifier of the decentralized wallet 614 in a look-up technique to identify a previously created record of a subscription for the decentralized wallet 614. The computer 612 can then change or replace the parameters for the subscription according to the parameters included in the message 618.

In some cases, the computer 612 can transmit content 620 to the account associated with the decentralized wallet 614 that has the subscription with the computer 612. For example, the computer 612 can be or include a software-as-a-service platform that is configured to transmit data to different consumers. A user subscribed to the software-as-a-service platform can login to an account the user has with the software-as-a-service platform and the computer can transmit content 620 to the computing device through which the user logged into the software-as-a-service platform. In another example, the computer 612 can be a streaming platform that streams content to users.

In some cases, the analytics server 602 can cause a transaction for the subscription to be written onto the blockchain 604. For example, the analytics server 602 can transmit a message to the computers 606 indicating (e.g., including) the parameters of the subscription as well, the identifier of the decentralized wallet 614 (e.g., the anonymized or the address of the decentralized wallet 614), and/or an identifier of the electronic transaction protocol 610 through which the subscription was created. The computers 606 can receive the message and append or write a block instance 622 to the blockchain 604 indicating the subscription.

The block instance 622 can include data for the subscription of the decentralized wallet 614 with the electronic transaction protocol 610. For example, the block instance 622 can include an electronic transaction protocol identifier 624, subscription data 626, and a hash 628. The electronic transaction protocol identifier 654 can be an identifier of the electronic transaction protocol 610. Such an identifier can be used (e.g., used by the computers 606 upon executing the electronic transaction protocol 610) to identify the subscription upon determining parameters of the subscription have been satisfied to initiate a payment for the subscription. The subscription data can include the parameters for the subscription. The hash 628 can be a hash that the computers 606 generate from the electronic transaction protocol identifier 624, the subscription data 626, any other data of the block instance 622, and the hash of the immediately previous block instance of the blockchain 604. The hash 628 can operate as the address for the block instance 622 and facilitate the block instance 622 being immutable.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various components, blocks, modules, circuits, and steps have been generally described in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What we claim is:

1. A method comprising:
monitoring, by a first system, one or more electronic transaction protocols deployed on a blockchain, wherein the one or more electronic transaction protocols correspond to one or more subscriptions provided by one or more service providers;
detecting, by the first system, an interaction by a decentralized wallet with a user interface element corresponding to a first electronic transaction protocol of the one or more electronic transaction protocols deployed on the blockchain, wherein the interaction corresponds to a request to create or modify a subscription with a first service provider of the one or more service providers, the request comprising an identifier associated with the decentralized wallet;
identifying, by the first system, one or more parameters of the subscription based on one or more inputs provided via the decentralized wallet, wherein the one or more parameters includes a time period of the subscription and a payment interval; and
in response to identifying the one or more parameters of the subscription and identifying that the first electronic transaction protocol corresponds to the first service provider, causing the first service provider to create or modify the subscription associated with a user of the decentralized wallet, wherein the causing further includes creating or modifying the subscription based on the one or more parameters.

2. The method of claim 1, further comprising:
in response to detecting that a payment is due for the subscription based on the one or more parameters of the subscription, causing a payment request to be provided to the decentralized wallet; and
based on approval of the payment request, causing the payment to be transmitted from the decentralized wallet to a decentralized wallet associated with the first system or associated with the first service provider, wherein causing the payment to be transmitted further includes causing a transaction corresponding to the payment to be written to the blockchain.

3. The method of claim 1, further comprising:
in response to detecting that a payment is due for the subscription based on the one or more parameters of the subscription, causing the payment to be transmitted from the decentralized wallet to a decentralized wallet associated with the first system or associated with the first service provider, wherein causing the payment to be transmitted further includes causing a transaction corresponding to the payment to be written to the blockchain.

4. The method of claim 1, further comprising:
in response to identifying the one or more parameters of the subscription, causing a transaction to be written to the blockchain that includes the one or more parameters of the subscription and the identifier of the decentralized wallet.

5. The method of claim 1, wherein causing the first service provider to create or modify the subscription associated with a user of the decentralized wallet comprises:
transmitting, by the first system to the first service provider, a message including the identifier of the decentralized wallet and the one or more parameters of the subscription.

6. The method of claim 1, further comprising:
detecting, by the first system, a second interaction by the decentralized wallet with a second user interface element corresponding to the first electronic transaction protocol, wherein the second interaction corresponds to a second request to revoke the subscription with the first service provider, the request comprising the identifier associated with the decentralized wallet; and
transmitting, by the first system, a message to the first service provider indicating the revocation of the subscription, receipt of the message causing the first service provider to delete the subscription from memory.

7. The method of claim 6, further comprising:
causing, by the first system, a transaction to be written to the blockchain that indicates the revocation of the subscription.

8. The method of claim 6, wherein receipt of the message causes the first service provider to stop providing content to an account associated with the subscription.

9. The method of claim 1, further comprising:
deploying, by the first system, the one or more electronic transaction protocols onto the blockchain.

10. The method of claim 1, further comprising:
detecting, by the first system, a second request to modify the subscription from a second interaction with the first electronic transaction protocol;
causing a second transaction to be written to the blockchain that includes the modification to the subscription and the identifier of the decentralized wallet.

11. The method of claim 1, further comprising:
storing, by the first system, a mapping of the identifier of the decentralized wallet to a anonymized identifier, wherein causing the first service provider to create or modify the subscription associated with a user of the decentralized wallet comprises:
transmitting, by the first system to the first service provider, a message including the anonymized identifier.

12. A system comprising:
a non-transitory computer-readable medium having a set of instructions that when executed by a processor, cause the processor to:
monitor one or more electronic transaction protocols deployed on a blockchain, wherein the one or more electronic transaction protocols correspond to one or more subscriptions provided by one or more service providers;
detect an interaction by a decentralized wallet with a user interface element corresponding to a first electronic transaction protocol of the one or more electronic transaction protocols deployed on the blockchain, wherein the interaction corresponds to a request to create or modify a subscription with a first service provider of the one or more service providers, the request comprising an identifier associated with the decentralized wallet;
identify one or more parameters of the subscription based on one or more inputs provided via the decentralized wallet, wherein the one or more parameters includes a time period of the subscription and a payment interval; and
in response to identifying the one or more parameters of the subscription and identifying that the first electronic transaction protocol corresponds to the first service provider, cause the first service provider to create or modify the subscription associated with a user of the decentralized wallet, wherein the causing further includes creating or modifying the subscription based on the one or more parameters.

13. The system of claim 12, wherein the set of instructions further cause the processor to:
in response to detecting that a payment is due for the subscription based on the one or more parameters of the subscription, cause a payment request to be provided to the decentralized wallet; and
based on approval of the payment request, cause the payment to be transmitted from the decentralized wallet to a decentralized wallet associated with the first system or associated with the first service provider, wherein causing the payment to be transmitted further includes causing a transaction corresponding to the payment to be written to the blockchain.

14. The system of claim 12, wherein the set of instructions further cause the processor to:
in response to detecting that a payment is due for the subscription based on the one or more parameters of the subscription, causing the payment to be transmitted from the decentralized wallet to a decentralized wallet associated with the first system or associated with the first service provider, wherein causing the payment to be transmitted further includes causing a transaction corresponding to the payment to be written to the blockchain.

15. The system of claim 12, wherein the set of instructions further cause the processor to:
in response to identifying the one or more parameters of the subscription, causing a transaction to be written to the blockchain that includes the one or more parameters of the subscription and the identifier of the decentralized wallet.

16. The system of claim 12, wherein the set of instructions cause the first service provider to create or modify the subscription associated with a user of the decentralized wallet by:
transmitting, to the first service provider, a message including the identifier of the decentralized wallet and the one or more parameters of the subscription.

17. The system of claim 12, wherein the set of instructions further cause the processor to:
detect a second interaction by the decentralized wallet with a second user interface element corresponding to the first electronic transaction protocol, wherein the second interaction corresponds to a second request to revoke the subscription with the first service provider, the request comprising the identifier associated with the decentralized wallet; and
transmit a message to the first service provider indicating the revocation of the subscription, receipt of the message causing the first service provider to delete the subscription from memory.

18. The system of claim 17, wherein the set of instructions further cause the processor to:
cause a transaction to be written to the blockchain that indicates the revocation of the subscription.

19. The system of claim 17, wherein receipt of the message causes the first service provider to stop providing content to an account associated with the subscription.

20. The system of claim 12, wherein the set of instructions further cause the processor to:
deploy the one or more electronic transaction protocols onto the blockchain.
